(19) United States
(12) Patent Application Publication
(10) Pub. No.: US 2014/0046861 A1
(43) Pub. Date: Feb. 13, 2014

(54) Method and System for Representing Collective and Individual Responses to a Shared Experience Event

(71) Applicant: James E. Dodson, AUSTIN, TX (US)

(72) Inventor: James E. Dodson, AUSTIN, TX (US)

(21) Appl. No.: 13/964,079

(22) Filed: Aug. 10, 2013

Related U.S. Application Data
(60) Provisional application No. 61/681,809, filed on Aug. 10, 2012.

(51) Int. Cl. G06Q 50/00; G06Q 10/00

(52) U.S. Cl. CPC G06Q 50/01; G06Q 10/00
USPC 705/319

(57) ABSTRACT

A web-based application for use on a mobile device allows a user to provide response input indicating the user's current positive/negative response, opinion, reaction, to an event or other shared experience and “publish” the response input data by broadcasting it to one or more other users or by providing the response input data to a centralized or distributed database or other repository of response input data from other individuals experiencing the same event. The application may acquire response input data from the repository or directly from one or more other users and display acquired response input data graphically or in some other concise and meaningful format that visually conveys the acquired response input data collectively and/or by individuals or groups or subgroups of individuals, thereby providing a means to acquire and characterize the time varying responses, opinions, and reactions of a population sharing the experience of an event or other stimulus.

### FIELD OF DISCLOSURE

The present disclosure relates to computer networks and, more specifically, applications enabling end user to communicate end user information and experiences.

### BACKGROUND

There is considerable research attempting to characterize and understand the dynamic emotions and opinions of people as they experience an event. Post-event surveys have been used for this purpose, but are generally capable only of gauging static assessments of an event as a whole. Written, self-reporting methods utilized during an event may provide a more dynamic representation of how an event affected or was perceived by people, but may also have the unintended effect of interrupting and altering the experience itself.

Robert W. Levenson and J. M. Gottman used a positive-negative effect rating dial to obtain reports of emotions during a research study in 1983. Participants turned a dial 100, illustrated in FIG. 1, having a pointer that rotated on a 180° scale divided into nine divisions ranging from very negative to neutral to very positive. Dial 100 was attached to a potentiometer in a voltage dividing circuit monitored by a computer that simultaneously monitored cardiovascular data of the participant. Participants were instructed to adjust the position of dial 100 as often as necessary so that it always reflected how positive or negative they were feeling moment-by-moment throughout a session.

Many people want to express their opinions or reactions to an event or other form of stimulus. People may also wish to access or otherwise obtain information indicating the current opinions of others during a shared experience, whether it be a sporting event, TV show, concert or any gathering of people for a common event. Historically, these desires have been achieved by means of face-to-face conversations, phone calls, letters, and other traditional forms of written and verbal communication. More recently, emails, text messages, and social network services allow people to exchange and broadcast opinions electronically.

### BRIEF DESCRIPTION OF THE DRAWINGS

FIG. 1 illustrates a rating dial faceplate according to the prior art;

FIG. 2 illustrates a method for representing opinions and reactions to an event;

FIG. 3 illustrates a server in one embodiment;

FIG. 4 illustrates a log-in screen in one embodiment;

FIG. 5 illustrates a profile screen in one embodiment;

FIG. 6 illustrates an event category screen in one embodiment;

FIG. 7 illustrates an event info screen in one embodiment;

FIG. 8 illustrates an opinion expression/monitoring user interface settings screen in one embodiment;

FIG. 9 illustrates an opinion expression/monitoring user interface in one embodiment;

FIG. 10 illustrates an opinion expression/monitoring user interface timeline screen in one embodiment;

FIG. 11 illustrates an interface for user's to build their own event in one embodiment; and

FIG. 12 illustrates a messaging screen in one embodiment.

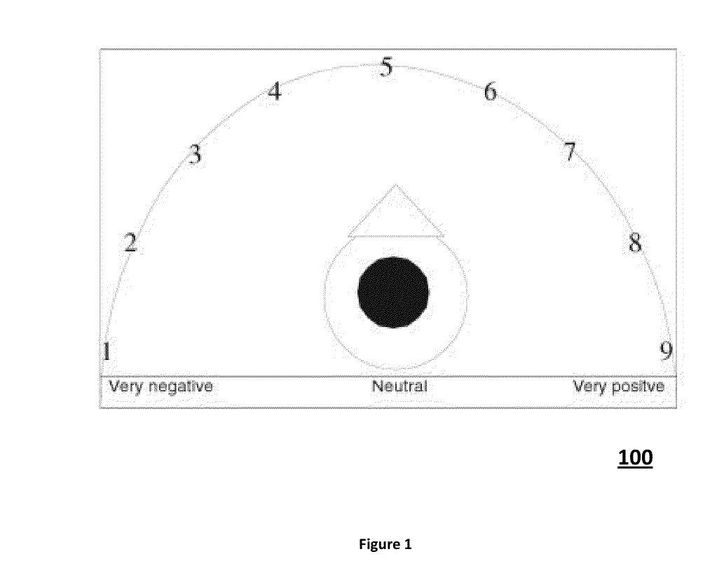

### DETAILED DESCRIPTION

Historical modes of interaction and expression may provide one with feedback from only one other person or from a relatively small group of people, which may not accurately reflect the collective shared experience of an applicable population as a whole. In addition, textual forms of expression may interrupt and alter an individual's experience during an event, thereby creating a tension between a desire for an increase in the amount and frequency of input from an individual and a desire to minimize disruptions that an individual experiences during the event. Additionally, while most people have opinions and reactions during an event, many may elect not to express those opinions textually for any number of reasons including the amount of time and effort required, anonymity concerns, and “self-doubt” concerns regarding whether their comments will be perceived as sufficiently articulate, clever, and popular by the intended and unknown recipients. The magnitude of at least some of these concerns has only increased with the size of the potential audience made possible by social network services and consumer-level broadcast services.

Included in subject matter disclosed herein is a web-based application for use on a mobile device or other type of networked computer that allows a user to provide response input indicating the user's current positive/negative response, opinion, reaction, to an event or other shared experience and “publish” response input data by broadcasting response input data to one or more other users or by providing the response input data to a centralized or distributed database or other repository of response input data from other individuals including, for example, other individuals experiencing the same event. In at least one embodiment, the application, sometimes referred to herein as the “pond application” also functions to acquire response input data from the repository or directly from one or more other users and display acquired response input data graphically or in some other concise and meaningful format that visually conveys the acquired response input data collectively and/or by individuals or groups or subgroups of individuals, thereby providing a means to acquire and characterize the time varying responses, opinions, and reactions of a population sharing the experience of an event or other stimulus. In at least one embodiment, the application generates a user interface that presents a visual representation of the user's own response input data, a visual representation of acquired response input data including the response input data of other individual users, as well as a visual representation of collective, aggregated response input data of a group or population of other individuals experiencing the shared event.

In at least one embodiment, a disclosed method, which may be performed by or otherwise suitable for a Web server or other type of application server executing a “pond application” for representing audience responses, opinions, or reactions to an event includes receiving, from a user device associated with a recognized user, response data corresponding to user input. The user input is indicative of a user response to that event and may include a time associated with the user input. In some embodiments, the time data may include time of day information and calendar date information as well. In some embodiments, the time data may be associated with the response input by a server or by a network resource intermediate between the user device and the server.

The method may include incorporating the response data into event data associated with the event. The event data may include response data associated with the event from a plurality of users. Upon receiving, from a requesting device, an event data request identifying the event and indicating an audience of interest, the method may include sending the requested event data to the requesting device.

The event may be a performance witnessed by an audience. The performance may be a live performance and the audience may be live audience attending the live performance. The live performance might include a concert, an athletic competition, a talent competition, a movie, a play, a lecture, a demonstration, a ceremony, a rally or any other suitable event. The performance could also be a prerecorded multimedia program and the audience might include a home audience watching the program via television, cable, satellite or the like. The audience of interest could include the user, another individual experiencing the event, or a group of individuals experiencing the event.

The method may include calculating or otherwise determining group response data corresponding to the group of individuals. The group response data may represent a collective response of the group of individuals to the event as a function of time. The collective response may be based on a straight or weighted average of the response data received from the audience of interest. For a weighted average, the weighting of the response data may be based on a weighting factor. The weighting factor could be associated with or indicative of one or more desired or selected characteristics of the audience of interest including, as an example, a demographic characteristic. A value of the characteristic may for any individual in the audience of interest may be accessed or otherwise obtained from a profile of individual. A database server that maintains the response data may also maintain user profile data or retrieve user profile data from the user devices as needed.

The preceding method may be implemented as computer executable program instructions, stored on a computer readable memory or other storage medium of or accessible to the pond application server. In this implementation, execution of the instructions by a processor in the server, causes the server to perform the described method. Similarly, another implementation of the method is directed at the server itself. In this implementation, the server includes a processor and memory or another storage medium accessible to the processor. The server also includes a network interface to communicate with the various user devices over any suitable form of wide area or local network including wireless networks, fixed media networks, public networks, packet switched networks including IP networks such as the Internet, and circuit switch networks.

In another aspect a client-side method disclosed herein may include responding to receiving a first user input indicative of an event, from a client device associated with a user, by associating the user with the event and responding to receiving second user input indicative a user response to the event by sending response data indicative of the user response and a time associated with the user response to a recipient. The recipient may be a pond application server, one or more other users experiencing the event, or another suitable recipient. The client side method may further include responding to receiving third user input indicating an audience of interest by sending an event data request identifying the audience of interest and responding to receiving requested data corresponding to the event data request by generating a response data display indicative of the requested data.

The client-side method may include displaying a first user interface indicating a plurality of events and receiving the first user input based on a user interaction with the first user interface. The various user interface described herein may be implanted in touch screen displays and the user interactions with the interfaces may refer to a user touching or otherwise contacting a specific location of the user interface. The client side method may include generating a response user interface and receiving the second user input from user interaction with the response user interface.

The audience of interest may refer to the user, another individual experiencing the event, a population of all individuals experiencing the event, a subgroup of the individuals experiencing the event, or another suitable audience. The audience of interest may be defined by subgroup of individuals defined by or based on a social network group of the user. For example, the audience of interest might include a user's Twitter followers that experiencing the event. In these embodiments, the user interfaces may be generated or displayed within the context of a social network service or application. In other implementations, the pond application is a standalone application that may interact with a contact list or with other applications installed on the user device to define a desired audience of interest. In some embodiments, the audience of interest is defined indicating a desired characteristic of the subgroup.

The response data display itself may include a “ripple line” indicating a magnitude of the requested response data as a function of time, i.e., a magnitude of the respondents individual or collective negative or positive response to the event. The response may be a digital response including, as an example, a “like” or “don't like” or an analog response capable of indicating a range of values. The magnitude of a response, either positive or negative, may be indicative by a distance between the location of a user's response input and a midline of the response data display, where the midline represents a neutral value. The response data display may include a plurality of ripple lines associated with a plurality of audiences of interest.

Another disclosed embodiment is directed to a client device that includes a processor, a touch screen display, a wireless communication interface, and a computer readable memory that is accessible to the processor. The memory includes program instructions that, when executed by the processor, cause the processor to perform the previously client side methods described above.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

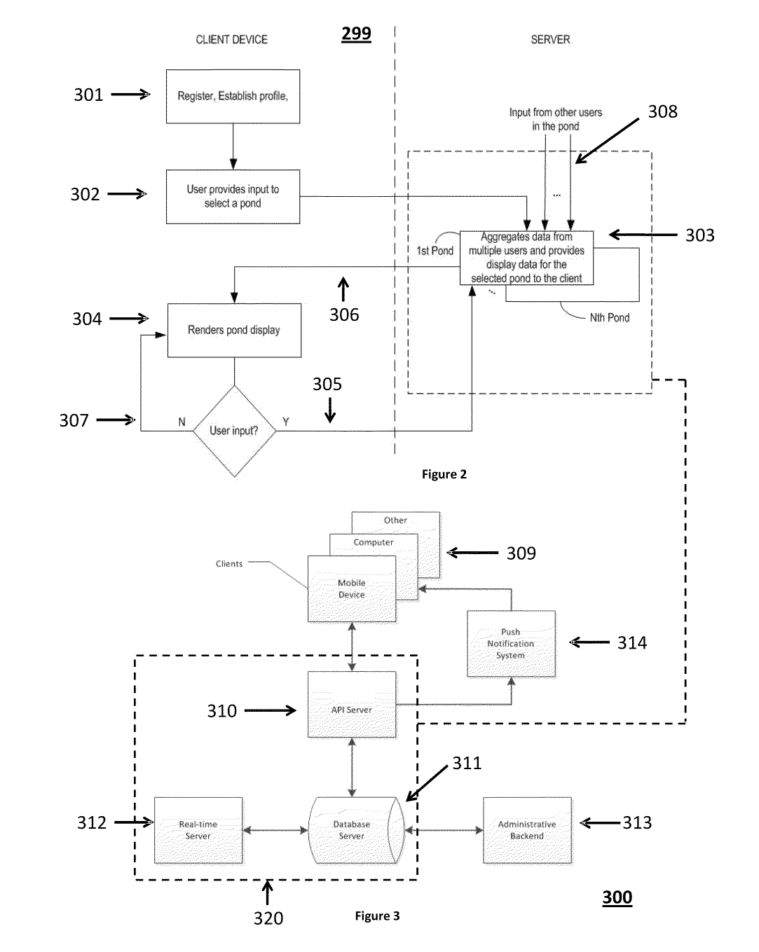

Turning now to the drawings, FIG. 2 illustrates a response input reporting and monitoring method 299. As illustrated in FIG. 2, method 299 is represented by operational blocks that are divided into operational blocks 301, 302, 304, and 307 performed by a client device and operational blocks 303 performed by a server. The illustration of some or all of the operational blocks depicted in FIG. 2 by either a client device or a server is an implementation consideration and some embodiments may vary with respect to whether a client device or a server performs an operation. FIG. 2 illustrates a user utilizing a mobile device or other type of networked computer to register and establish (operation 301) a personal profile. FIG. 2 illustrates a user providing (operation 302) an input selecting, indicating, or otherwise associating the user with a specific event or “pond” 303 maintained by the server.

As illustrated in FIG. 2, the server system aggregates (operation 303) response inputs 308 from multiple other users associated with the pond selected by the client device. Although not illustrated explicitly in FIG. 2, the server receives response inputs analogous to responses inputs 308 for each of the ponds that the server maintains and sends (operation 306) response input data for the selected pond to the client device. FIG. 2 illustrates the client device rendering (operation 304) a display identified as a pond display based on the pond-specific response input data received from the server.

FIG. 2 also illustrates the client device monitoring (operation 307) for any response input provide by the user and responding whenever user-generated response input is detected, by providing (operation 305) the response input to the server system.

In at least one embodiment, the client device includes a touch screen display and the user-generated response input that indicates positive/negative response, opinion, or reaction of the user is generated when taps or clicks on the user's display. This input may be referred to herein as a “ripple” while a user input providing, textual, audio, or video input to other users may be referred to herein as a “splash.” The client device may also receive and process user input that conveys change in “pond settings,” which control how client device renders the response input data acquired from the server data based on the user's preferences.

FIG. 3 illustrates a platform 300 suitable for implementing methods and applications described herein. The platform 300 illustrated in FIG. 3 encompasses client-side devices and features and server-side systems and features. The client device 309 may be implemented as a mobile device (e.g. wireless smart phone) or other type of networked computer capable of accessing the Web or another public or private wide area network. In at least one embodiment, client device 309 includes a processor, a touch screen display, a wireless communication interface, and memory or other computer readable storage medium, accessible to the processor, that includes processor executable program instructions that upon execution by the processor, cause the processor to perform operations described herein.

As illustrated in FIG. 3, platform 300 includes a pond server 320 that communicates with the client device 309. In at least one embodiment, pond server 320 includes a processor, a network interface, which may include wireless communication interface, and memory or other computer readable medium including program instructions executable by the processor where the program instructions, upon execution by the processor, cause the processor to perform operations described herein.

The pond server 320 illustrated in FIG. 3 includes an API server 310, a real-time server 312, and a database server 311. In some embodiments, ponder server 320 may include more or fewer elements and may integrate any two or more of the illustrated elements. In at least one embodiment, API Server 310 processes the majority of client requests. FIG. 3 illustrates API server 310 connected to database server 311 in order to record the response inputs reflecting the self-reported, positive/negative response, opinions, or reaction of the users to the shared events. API server 310 may also process user messages and text, audio, and video objects associated therewith. API server 310 may perform other functions to interact with the client devices and with the instances of the client device applications executing on those devices.

In some embodiments, real-time server 312 distributes the continuous stream of response input data received from the applicable client devices for each pond to facilitate the client-side rendering of a pond display, i.e., a display representative of response input data acquired by a client device 309 from ponder server 320 with minimum latency. In some embodiments, real-time server 312 may run alongside or otherwise support or interact with the API server 310 to support real-time data needs of client 309.

The platform 300 illustrated in FIG. 3 further depicts an administrative backend 313 that may represent a device and/or application that enables one or more moderators to perform administrative functions including, as examples, manage users, manage the ponds or shared that the pond server 320 supports, monitor various volume, capacity, and performance metrics for pond server 320, provide and monitor security measures, and to generate various corresponding reports.

In the platform 300 illustrated in FIG. 3, database server 311 is responsible for real-time data collection and for processing database queries generated by API server 310 in response to inputs from client devices 309. In some embodiments, database server 311 performs data minification and archiving tasks, data aggregation and query acceleration, and calculating and otherwise processing incoming data (e.g. aggregated responses). In the illustrated platform 300, database server 311 connects, bridges, or is accessible to API server 310, real-time server 312, administrative backend 313.

FIG. 3 further illustrates a push notification system 314 that may be included in platform 300 to notify clients 309 of events including, as example, when a client device 309 is not currently executing the pond application in the foreground.

Although omitted from FIG. 3 to improve clarity and focus, clients 309 and pond server 320 communicate with each other over a network. In at least one embodiment, pond server 320 is implemented as or includes a Web server and clients 309 are implemented as or include a web browser that enable pond server 320 and clients 309 to communicate over the World Wide Web. It will also be appreciated by those of skill in the field of public and private communication networks that the communication between clients 309 and pond server 320 may include cellular telephone network elements, “open wireless” network elements such as a WiFi element, packet switched network elements including the Internet and/or other public or private IP networks, and circuit switched elements including, as an example a public switched telephone network.

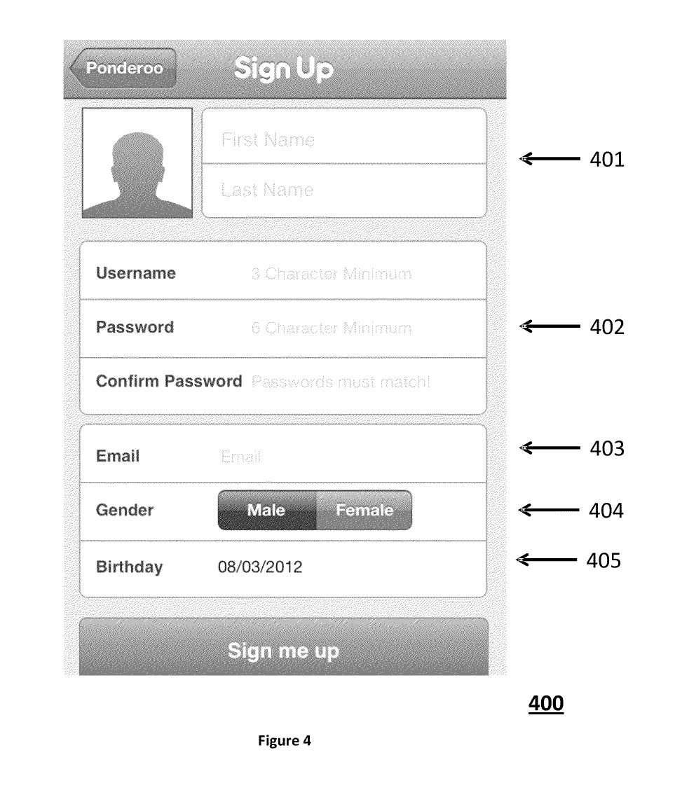

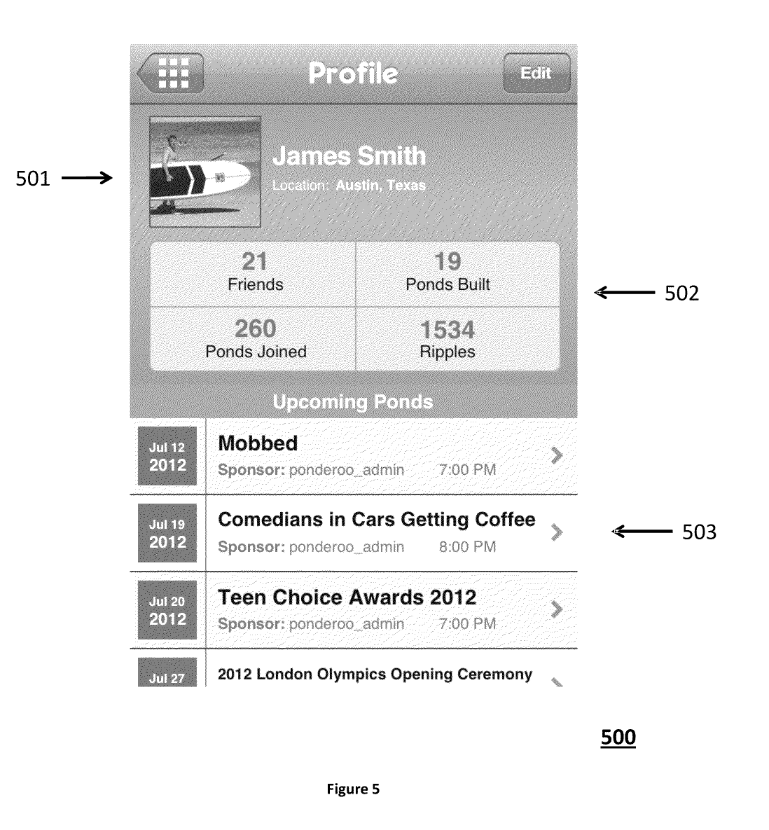

In some embodiments the pond application is initiated when the user downloads the application to his/her client device and launches it for execution. Upon launch of the application, the user may be presented with one or more graphical user interfaces, each of which may facilitate user input and/or provide information. The user may also be asked whether he/she will allow the application to use his/her current location either via location services within the device, or via manual entry by the user. FIG. 4 depicts one implementation of a sign up user interface 400. The user may also be asked whether he/she will allow the application to use his/her current location either via location services within the device, or manual entry by the user. Sign up user interface 400 may permit the user to enter his/her first and last name 401, establish a user name and password 402, enter his/her email address 403, indicate his/her gender 404, and enter his/her birthday 405. The user may also have the option to link his/her actions on the application to social media accounts selected by the user.

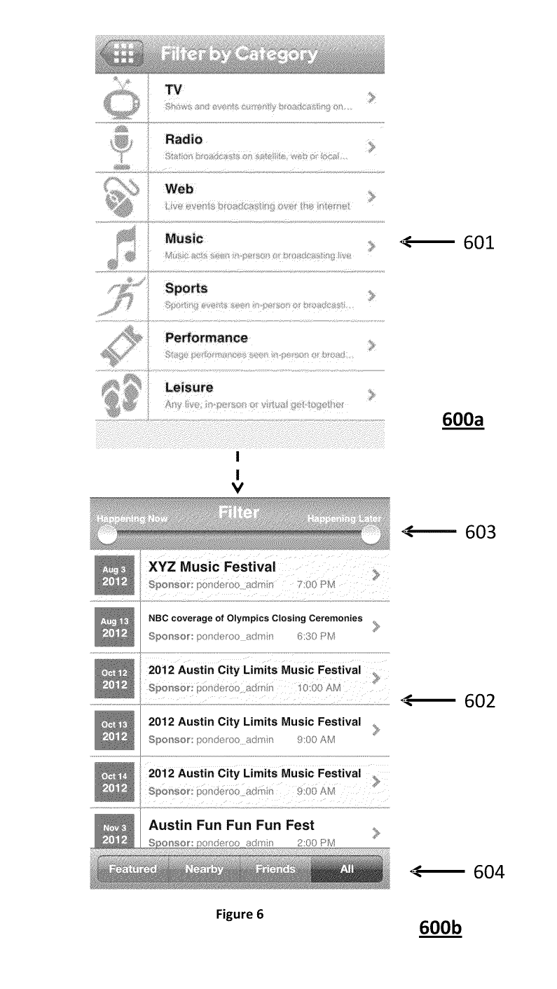

The application may provide the user with access to a profile user interface 500 where the user can further enhance his/her profile. In the embodiment of profile user interface 500 depicted in FIG. 5, the user may add an image which represents the user visually within the application. The Profile user interface 500 may also show a summary 502 of the user's previous activity within the application, as well as a list 503 of the user's upcoming events/happenings (called “ponds” within the application) that can be experienced with other people.

In some embodiments, the user may select an event from list 503 to enter the corresponding pond. Upon entering a pond, the application may present the user with a pond display such as the display 900 described below. Alternatively, the user may find, select, and/or enter a new pond via category user interface 600a and/or 600b as depicted in FIG. 6. The category user interface 600a may show the various categories of ponds that are available for the user to join. Categories 601 can include, as examples, TV, radio, web, music, sports, performance, and leisure. By opening a particular category, the user may be provided with a list of pond options 602. If desired, the user can also conduct a chronological search within a category to find a particular pond using a “when happening” feature 603. The user can also sort pond options based on a classification related to the event via the category bar 604. The classifications may include a featured classification (key pond built by application moderators), a nearby classification (ponds taking place near the user based on client device location services), a friends classification (ponds built by the user's friends), and an all classification (covers all ponds within the category). Other implementations may include more, fewer, and/or different classifications.

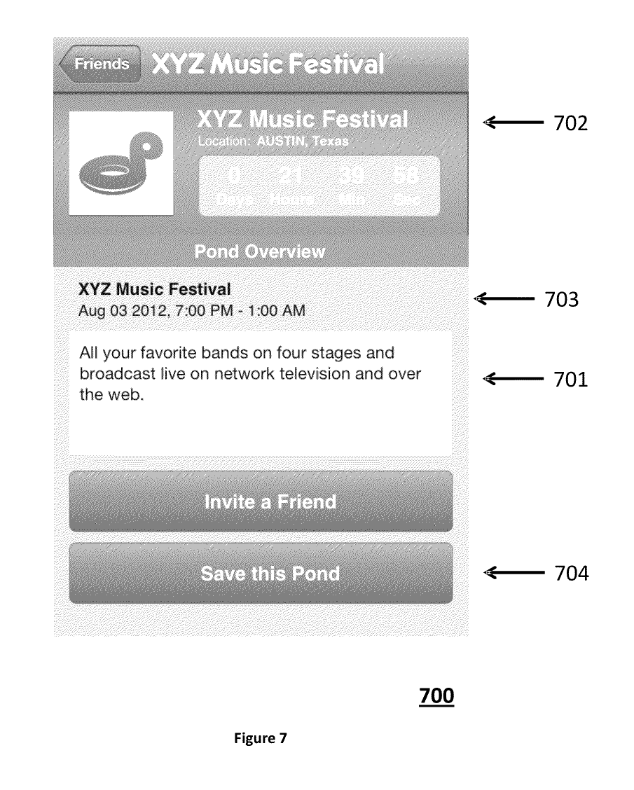

As shown in FIG. 7, which depicts a representative pond user interface 700, once the desired pond is found, the user can view information about the pond 701, including where it is taking place 702, and the date/time (whether attending live, or through broadcast) 703. The user may be able to save the pond to be reminded at a later date if the pond will be taking place in the future 704. If the pond is currently active, the user may be able to join immediately.

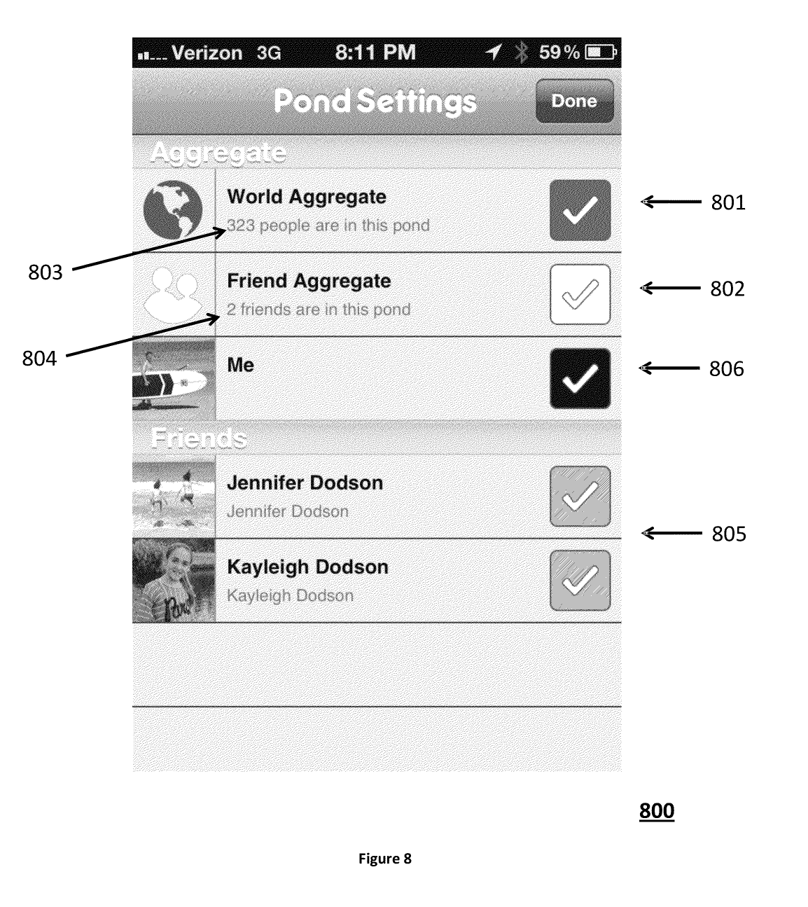

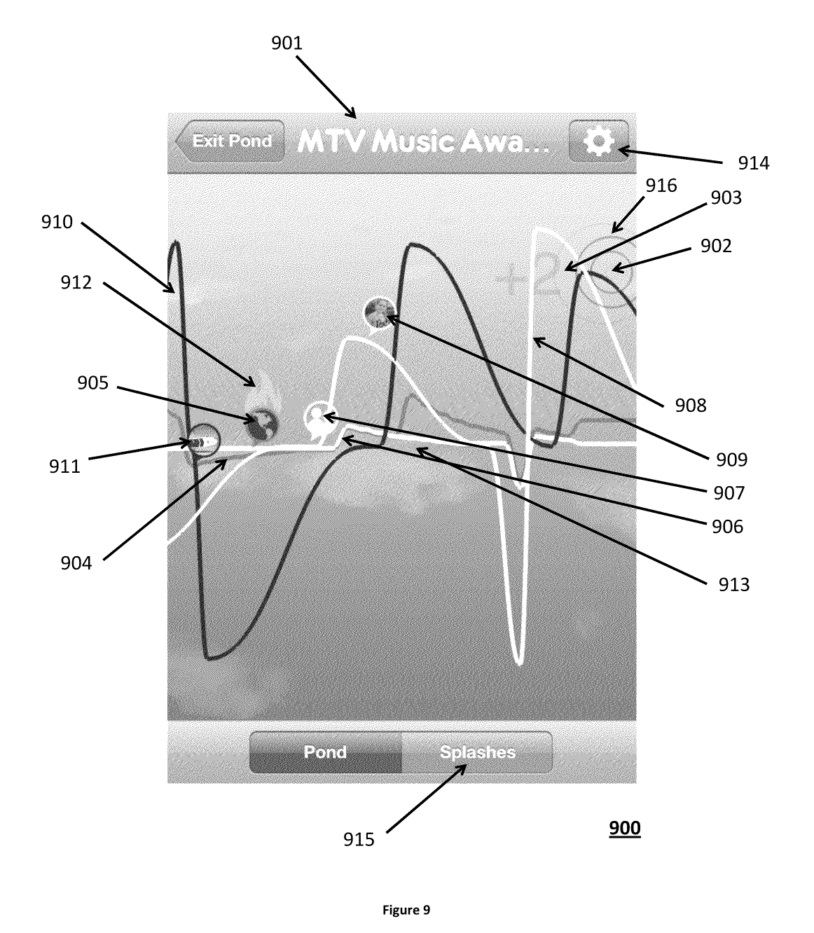

After entering a pond, the user may be presented with a pond setting user interface 800 for setting a variety of options in the settings screen, as shown in FIG. 8. In the depicted embodiment of user interface 800, the user can customize the settings to change what he/she sees in the pond screen (shown in FIG. 9). The user can customize the aggregates that are visible in his/her view of the pond to include, as examples, a world aggregate 801 and/or a friends aggregate 802. The world aggregate may represent the combined response input of everyone in the pond, while the friend aggregate may provide the combined feedback of all of the user's friends in the pond. This aggregated data can be filtered by the user with input requests to the server, or the aggregated data can filtered locally on the user's device. The overall number of people in the pond (World) 803, and the number of the user's friends in the pond 804 may also be displayed. The user may also be able to turn on and off the individual feedback of his/her friends that are in the pond 805. The user may also be able to turn on and off his/her own visual feedback 806 once in the pond.

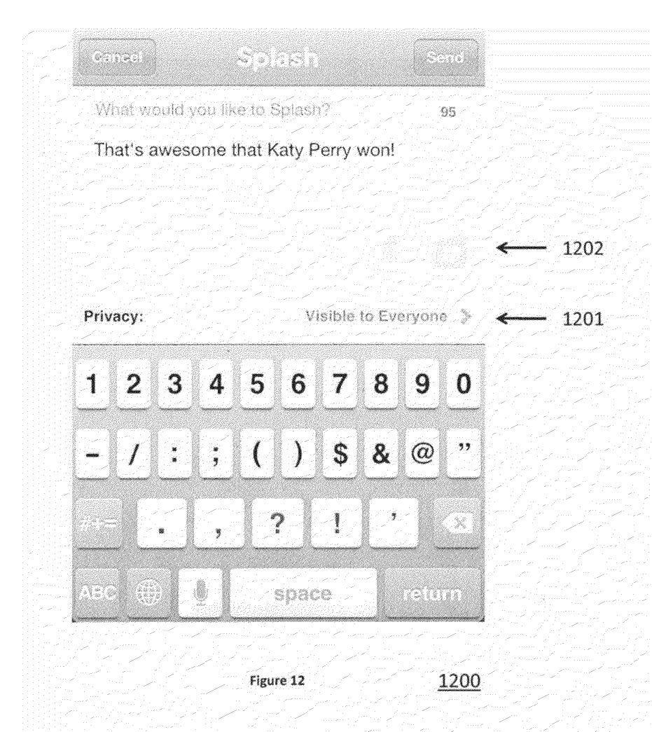

FIG. 9 is representative of a user interface of the application that displays one or more time varying ripple lines indicative of overall collective or individual response or reaction to an event or time slices of the event. Once in the pond, a pond title 901 may be listed at the top. When a user wants to provide their positive/negative opinion to the pond, he/she may do so by touching or clicking the device's screen above or below a midline 913. In the depicted embodiment, a visual acknowledgement of the touch or click, called a “ripple” 916, is displayed. A number value 903 may appear next to ripple 916 showing the user that his/her opinion has been registered. The higher the user touches/clicks above the midline 913, the more favorable (positive) the user feels about what he/she is seeing, hearing and/or experiencing at that moment. Conversely, the lower below the midline, the more unfavorable (negative) the user feels about what he/she is seeing, hearing and/or experiencing at that moment. A number 903 may be displayed on screen to indicate the magnitude of the user's positive or negative opinion, relative to the neutral midline. The user can also see on the screen a ripple line 904 (with a globe icon 905) that represents, in real time, the aggregated or collective opinions of all users in the pond; a colored moving ripple line 906 (with a silhouetted people icon 907) that represents the aggregated opinions of all the user's friends in the pond; and/or individual, colored, moving ripple lines 908 (with an icon that contains the friend's profile graphic 909) that represent the individual opinions of friends that the user has opted to see in the pond. The user can also see a colored, moving line 910 (with his/her chosen profile visual 911) that represents his/her action of touches/clicks in the pond, also in real time. The user can select any combination of these ripple lines to display. To show passage of time, the ripple lines, indicating positive/negative opinions, move from right to left until they exit the screen. If a large number of users in a specific pond all ripple their positive/negative opinions within a short period of time, an icon appears above the world icon to indicate to the user that a large collective response has occurred 912. The user may access the settings of the pond (see FIG. 8) by initiating the cog icon button 914. Should the user wish to send a text message to either a specific friend in the pond or everyone in the pond (World), the user may do so by initiating the “splashes” button 915, as covered in FIG. 12.

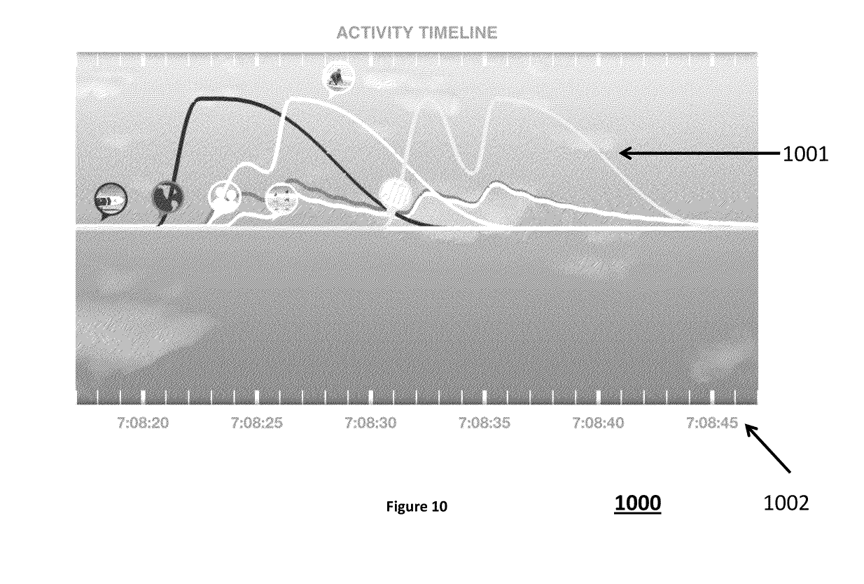

In an embodiment depicted in FIG. 10, the user may also have the option to change the screen to reflect a timeline of the pond, as shown in FIG. 10. This view allows the user to scroll back/forth to explore the history of positive/negative ripple lines in the pond 1001 that have occurred over the time that the pond has been active. Time markers 1002 at the base reflect a chronology of the various positive/negative ripple lines.

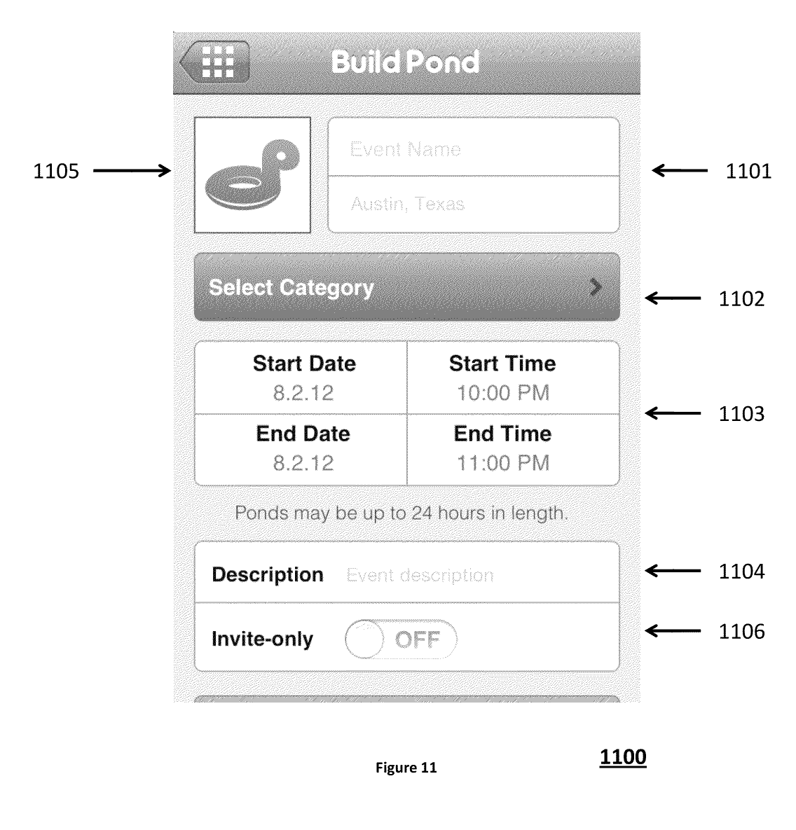

While many ponds may be built by the site administrator, users are also provided the opportunity to build ponds themselves, as shown in FIG. 11. In this embodiment, the application allows the user the ability to name the pond via input 1101, select a category/categories to make the pond easier to find by other users with a search process via input 1102, select a date and opening/closing time for the pond via input 1103, provide a brief description via input 1104, add a visual via input 1105, and choose whether the pond can be seen by only select friends, or whether all users have access to the pond via input 1106.

If the user would also like to send a message to another user in the pond, this can be accomplished within the pond through an interface which allows for messaging, as shown in FIG. 12. A user can customize who receives the message within the pond 1201, whether it is an individual person, only the user's friends, or everyone in the pond. The messaging interface also allows users to share their messages through other social media platforms 1202. Some embodiments may employ permission policies by which a user may be required to request and obtain a friend's permission before the user may communicate with the friend and/or receive and display data indicative of the friend's responses to events.

If the electronic device being utilized by the user also receives auditory signals from the user's environment, the application may be able to sync users together in the pond, even if all users are not experiencing the event at exactly the same time. For example, two friends are experiencing a sports event; one user is in attendance at the event and the other user is watching the event on television. The user watching it on television is likely actually seeing the event a few seconds later than what is actually occurring due to a multiple-second delay created by the television network. Therefore the real-time reporting between the two users would be slightly off. To account for this difference in time, device matches auditory cues between the two environments (in-person sounds versus broadcast sounds of the event) to sync the pond display and timeline between the two users.

If the user is viewing or listening to the event/program through a client device that is also utilizing the application, the application runs concurrently on top of the viewing platform (e.g. screen), allowing the user to utilize the application and the view or listen to the event at the same time, within the same client device.

Should the user desire to see further demographic breakdown of the opinions being registered by those in the pond, he/she may do so in the pond settings screen by selecting age, gender, geographic, and other differentiators, at least to the extent that these parameters have been specified by other users.

Data about users' chronological positive and negative opinions about an event are captured and analyzed by the back-end administration, and will provide valuable, event/program-specific feedback to event producers and marketers interested in a specific target market and their real-time reactions to said event/program.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for representing responses to an event, the method comprising:
receiving, from a user device associated with a recognized user, response data corresponding to user input indicative of a user response to an event and a time associated with the user input;
incorporating the response data into event data associated with the event, wherein the event data includes response data associated with the event from a plurality of users; and
responsive to receiving, from a requesting device, an event data request identifying the event and indicating an audience of interest, sending the requested event data to the requesting device.

2. The method of claim 1, wherein the event comprises a performance witnessed by an audience.

3. The method of claim 2, wherein the performance is a live performance and the audience is a live audience attending the live performance.

4. The method of claim 3, wherein the performance is selected from: a concert, a competition, a movie, a play, a lecture, a demonstration, a ceremony, and a rally.

5. The method of claim 1, wherein the performance comprises a prerecorded multimedia program and the audience comprises a home audience.

6. The method of claim 1, wherein the audience of interest is selected from: the user, an individual other than the user experiencing the event, and a group of individuals experiencing the event.

7. The method of claim 6, further comprising:
determining group response data corresponding to the group of individuals, wherein the group response data is indicative of a collective response of the group of individuals to the event as a function of time.

8. The method of claim 7, wherein the collective response is based on an average of the response data received from the audience of interest.

9. The method of claim 8, wherein the average of the response data is a weighted average, wherein a weighting of the response data is based on a weighting factor.

10. The method of claim 9, wherein the weighting factor is associated with a characteristic and wherein a value of the characteristic for an individual is indicated in the profile of individual.

11. A client device method, comprising:
responsive to receiving first user input indicative of an event, from a client device associated with a user, associating the user with the event;
responsive to receiving second user input indicative a user response to the event, sending response data indicative of the user response and a time associated with the user response to a recipient;
responsive to receiving third user input indicating an audience of interest:
sending an event data request identifying an audience of interest; and
responsive to receiving requested data corresponding to the event data request, generating a response data display indicative of the requested data.

12. The method of claim 11, further comprising:
displaying a first user interface indicating a plurality of events; and
receiving the first user input based on a user interaction with the first user interface.

13. The method of claim 12, further comprising:
generating a response user interface; and
receiving the second user input from user interaction with the response user interface.

14. The method of claim 11, wherein the audience of interest comprises an audience selected from: the user, another individual experiencing the event, a population of all individuals experiencing the event, a subgroup of the individuals experiencing the event.

15. The method of claim 14, wherein the subgroup of individuals may be associated with a social network group defined by the user.

16. The method of claim 14, wherein the subgroup of individuals may be indicated by indicating a desired characteristic of the subgroup.

17. The method of claim 11, wherein the response data display includes a ripple line indicating a magnitude of the requested response data as a function of time.

18. The method of claim 17, wherein receiving user response data comprises detecting a distance between a position of a user interaction with the response data display and a midline of the display.

19. The method of claim 17, wherein the response data display includes a plurality of ripple lines associated with a plurality of audiences of interest.

20. A client device, comprising:
a processor;
a touch screen display;
a wireless communication interface; and
a computer readable memory, accessible to the processor, including program instructions that, when executed by the processor, cause the processor to perform the method of claim 11.

21. An application server, comprising:
a processor;
a wireless communication interface; and
a computer readable memory, accessible to the processor, including program instructions that, when executed by the processor, cause the processor to perform operations comprising:
receiving, from a user device associated with a recognized user, response data corresponding to user input indicative of a user response to an event and a time associated with the user input;
incorporating the response data into event data associated with the event, wherein the event data includes response data associated with the event from a plurality of users; and
responsive to receiving, from a requesting device, an event data request identifying the event and indicating an audience of interest, sending the requested event data to the requesting device.
